(19) United States
(12) Patent Application Publication
(10) Pub. No.: US 2026/0146684 A1
(43) Pub. Date: May 28, 2026

(54) PIPE OR CONDUIT SECTION ALIGNMENT APPARATUS

(71) Applicant: Walhonde Tools, Inc., South Charleston, WV (US)

(72) Inventor: Matthew McClure, South Charleston, WV (US)

(21) Appl. No.: 18/957,820

(22) Filed: Nov. 24, 2024

(51) Int. Cl. F16L 1/10; F16L 13/02

(52) U.S. Cl. CPC F16L 1/10; F16L 13/02

(57) ABSTRACT

An apparatus for aligning sections of pipe, the apparatus comprising a first clamp member comprising a first clamp jaw and a second clamp jaw longitudinally spaced from the first clamp jaw and a second clamp member comprising a first clamp jaw and a second clamp jaw longitudinally spaced from the first clamp jaw. The apparatus comprises a first plurality of swivel mount assemblies, each one of the first plurality of swivel mount assemblies being coupled with each one of, and adjustable to vary the longitudinal spacing between, the first clamp jaw and the second clamp jaw of the first clamp member, and further includes a second plurality of swivel mount assemblies, each one of the second plurality of swivel assemblies being coupled with each one of, and adjustable to vary the longitudinal spacing between, the first clamp jaw and the second clamp jaw of the second clamp member.

### I. RELATED APPLICATIONS

There are no previously filed, nor currently any co-pending applications, anywhere in the world.

### II. FIELD OF THE INVENTION

This application discloses claims and embodiments generally related to an apparatus that serves to hold the adjacent ends of two separate sections of pipe securely, so that they may be effectively welded or otherwise joined to form a single continuous pipe.

III. BACKGROUND OF THE INVENTION

Known devices for aligning two adjacent sections of pipe, to facilitate welding the sections of pipe together, include devices that are capable of adjusting the longitudinal and lateral positions of the sections of pipe, and within certain limitations, of adjusting the orientations of the end faces of the sections of pipe between an angular orientation and a parallel orientation.

Numerous attempts have been made to improve such pipe straightening and/or joining apparatuses and/or devices. Accordingly, a need exists for an improved pipe or conduit alignment and coupling apparatus or device.

### IV. SUMMARY OF THE INVENTION

In one embodiment, an apparatus for aligning sections of pipe, the apparatus comprising a first clamp member comprising a first clamp jaw and a second clamp jaw longitudinally spaced from the first clamp jaw and a second clamp member comprising a first clamp jaw and a second clamp jaw longitudinally spaced from the first clamp jaw. The apparatus includes a first hinge comprising an elongated portion having a first aperture and a second aperture wherein the first aperture is spaced apart from the second aperture, the first hinge having a first pivot member inserted through the first aperture of the first hinge and pivotally coupling the first hinge to the first clamp jaw of the first clamp member, and the first hinge further having a second pivot member inserted into the second aperture of the first hinge and pivotally coupling the first hinge to the first clamp jaw of the second clamp member. The apparatus also includes a second hinge comprising an elongated portion having a first aperture and a second aperture wherein the first aperture is spaced apart from the second aperture, the second having including a third pivot member inserted through the first aperture of the second hinge and pivotally coupling the second hinge to the second clamp jaw of the first clamp member, and further including a fourth pivot member inserted into the second aperture of the second hinge and pivotally coupling the second hinge to the second clamp jaw of the second clamp member. The apparatus also comprises a first plurality of swivel mount assemblies, each one of the first plurality of swivel mount assemblies being coupled with each one of, and adjustable to vary the longitudinal spacing between, the first clamp jaw and the second clamp jaw of the first clamp member, and further includes a second plurality of swivel mount assemblies, each one of the second plurality of swivel assemblies being coupled with each one of, and adjustable to vary the longitudinal spacing between, the first clamp jaw and the second clamp jaw of the second clamp member.

The apparatus includes clamp members, wherein each one of the first clamp member and the second clamp member is pivotable between an open position and a closed position. The first clamp member is secured to the second clamp member when each one of the first clamp member and the second clamp member is in the respective closed position. Each one of the first clamp jaw of the first clamp member and the first clamp jaw of the second clamp member is configured to surround and engage a respective portion of a first section of pipe when each one of the first clamp member and the second clamp member is in the respective closed position. And, each one of the second clamp jaw of the first clamp member and the second clamp jaw of the second clamp member is configured to surround and engage a respective portion of a second section of pipe when each one of the first clamp member and the second clamp member is in the respective closed position.

The apparatus further comprises a plurality of swivel mounts, each one of the swivel mounts comprising a rear swivel mount and a forward swivel mount integral with the rear swivel mount. Each one of a first plurality of the swivel mounts couples a respective one of the first plurality of swivel mount assemblies with the first clamp jaw of the first clamp member. Each one of a second plurality of the swivel mounts couples a respective one of the first plurality of swivel mount assemblies with the second clamp jaw of the first clamp member. Each one of a third plurality of the swivel mounts couples a respective one of the second plurality of swivel mount assemblies with the first clamp jaw of the second clamp member. And, each one of a fourth plurality of the swivel mounts couples a respective one of the second plurality of swivel mount assemblies with the second clamp jaw of the second clamp member.

### V. BRIEF DESCRIPTION OF THE DRAWING(S)

The advantages and features of the present invention will become better understood with reference to the following more detailed description and claims taken in conjunction with the accompanying drawings, in which like elements are identified with like symbols, and in which:

FIG. 1 is a perspective view of a pipe sectiona alignment apparatus depicted in a closed position;

FIG. 2 is a top view of FIG. 1;

FIG. 3 is a bottom view of FIG. 1;

FIG. 4 is a side view of FIG. 1;

FIG. 5 through FIG. 8 are top, side, and perspective views of a swivel mount assembly;

FIG. 9 through FIG. 14 are exploded perspective views of the pipe section alignment apparatus is depicted.

### VI. DETAILED DESCRIPTION OF THE EMBODIMENT(S)

It will be readily understood that the components of the present invention, as generally described and illustrated in the figures herein, may be arranged and designed in a wide variety of different configurations. Thus, the following detailed description of the embodiments, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, the usage of the phrases “example embodiments”, “some embodiments”, or other similar language, throughout this specification refers to the fact that a particular feature, structure, or characteristic described in connection with the embodiment may be included in at least one embodiment of the present invention. Thus, appearances of the phrases “example embodiments”, “in some embodiments”, “in other embodiments”, or other similar language, throughout this specification do not necessarily all refer to the same group of embodiments, and the described features, structures, or characteristics may be combined in any suitable manner in one or more embodiments.

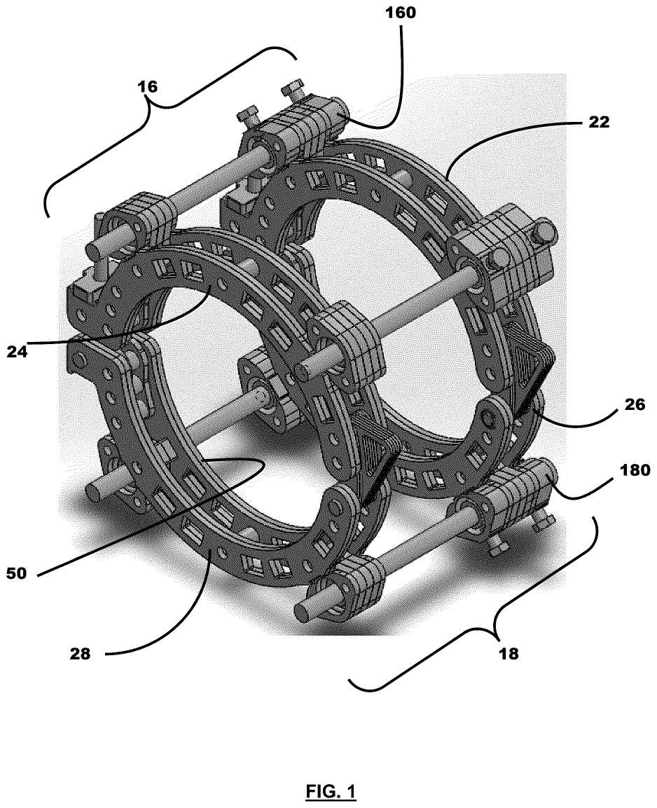

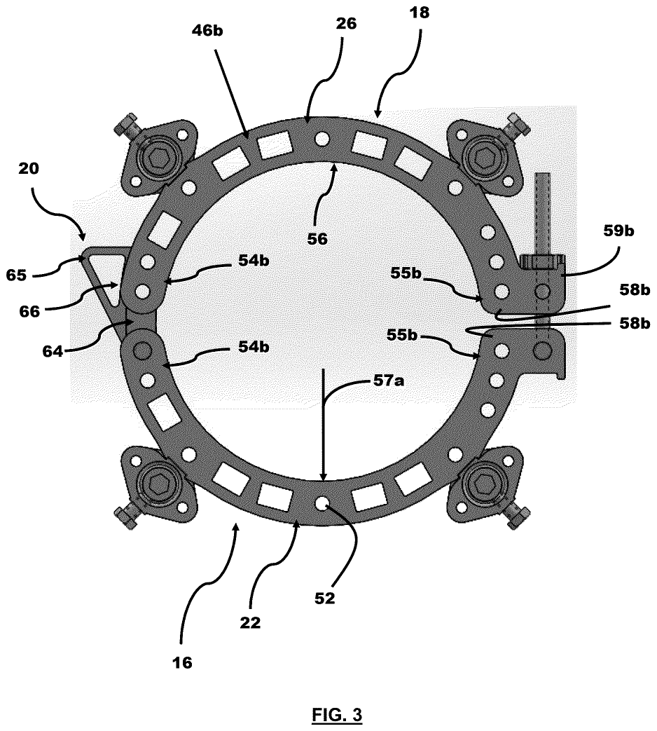

Referring to the drawings, wherein like reference numbers indicate the same or corresponding elements throughout the views, FIGS. 1-3 illustrate an apparatus 10 for aligning sections of pipe according to one embodiment. Apparatus 10 can be used to align two adjacent sections of pipe, and to securely hold the two sections of pipe, to facilitate welding, or otherwise joining, the sections of pipe together to form a single, continuous pipe. For example, FIG. 1 illustrates apparatus 10 in surrounding relationship with a first section of pipe P1, and an adjacent, second section of pipe P2, to facilitate welding pipe sections P1 and P2, or to facilitate joining pipe sections P1 and P2 using a different process.

Referring to FIGS. 1-3, apparatus 10 can include a first clamp member 16 and a second clamp member 18, which can be coupled with the first clamp member 16. In one embodiment, the first clamp member 16 can be hingedly coupled with the second clamp member 18 with a pair of hinges 20. Each one of the first clamp member 16 and the second clamp member 18 can be pivotable between an open position and a closed position. The first clamp member 16 and the second clamp member 18 can be opened sufficiently to receive first and second sections of pipe (P1, P2). Each one of the first clamp member 16 and the second clamp member 18, as well as other components of the apparatus 10, can be constructed from stainless steel, or any other durable and strong metal alloy or metal. Each of the hinges 20 can be constructed from a plurality of plates 21, for example, two or more plates 21. Alternatively, each hinge 20 can be constructed from a single member, for example, a single plate.

The first clamp member 16 can include a first clamp jaw 22 and a second clamp jaw 24 longitudinally spaced from the first clamp jaw 22. The second clamp member 18 can include a first clamp jaw 26 and a second clamp jaw 28 longitudinally spaced from the first clamp jaw 26. Each one of the first clamp jaw 22 of the first clamp member 16 and the first clamp jaw 26 of the second clamp member 18 can be pivotally coupled with a first one of the hinges 20, and each one of the second clamp jaw 24 of the first clamp member 16 and the second clamp jaw 28 of the second clamp member 18 can be pivotally coupled with a second one of the hinges 20.

Each one of the first clamp jaw 22 of the first clamp member 16, and the first clamp jaw 26 of the second clamp member 18, can be configured to surround and engage respective portions of a first section of pipe P1, for example, respective portions of the first section of pipe P1, as shown in FIG. 1, when each one of the first clamp member 16 and the second clamp member 18 is in the respective closed position. Each one of the second clamp jaw 24 of the first clamp member 16, and the second clamp jaw 28 of the second clamp member 18, can be configured to surround and engage respective portions of a second section of pipe P2, for example, respective portions of the second section of pipe P2, as shown in FIG. 1, when each of the first clamp member 16 and the second clamp member 18 is in the respective closed position. The first clamp member 16 can be secured to the second clamp member 18 when each is in the respective closed position. In one embodiment, the first clamp member 16 can be clamped to the second clamp member 18 when each is in the respective closed position.

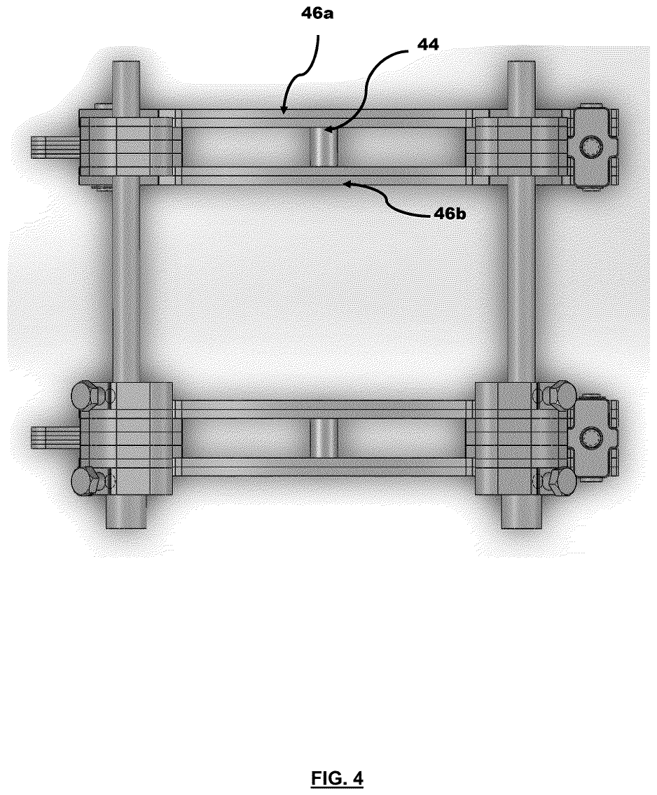

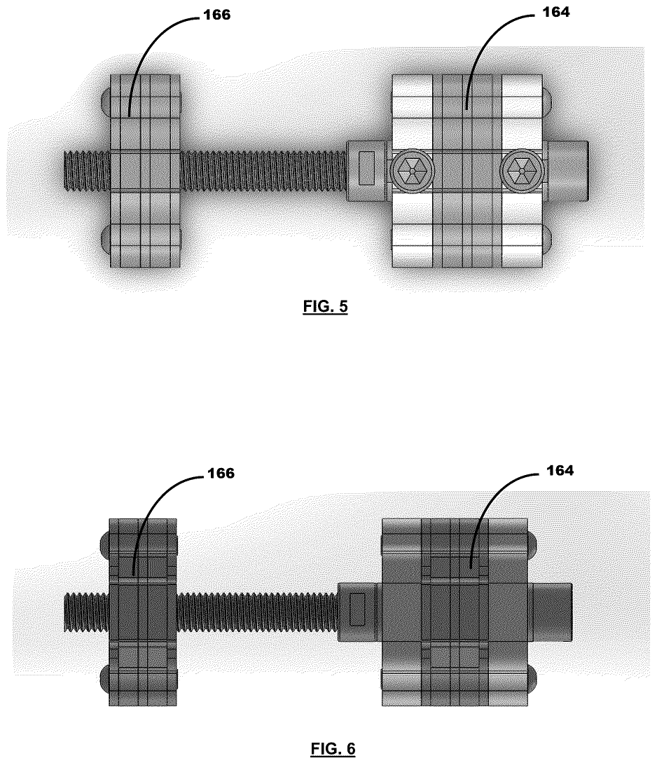

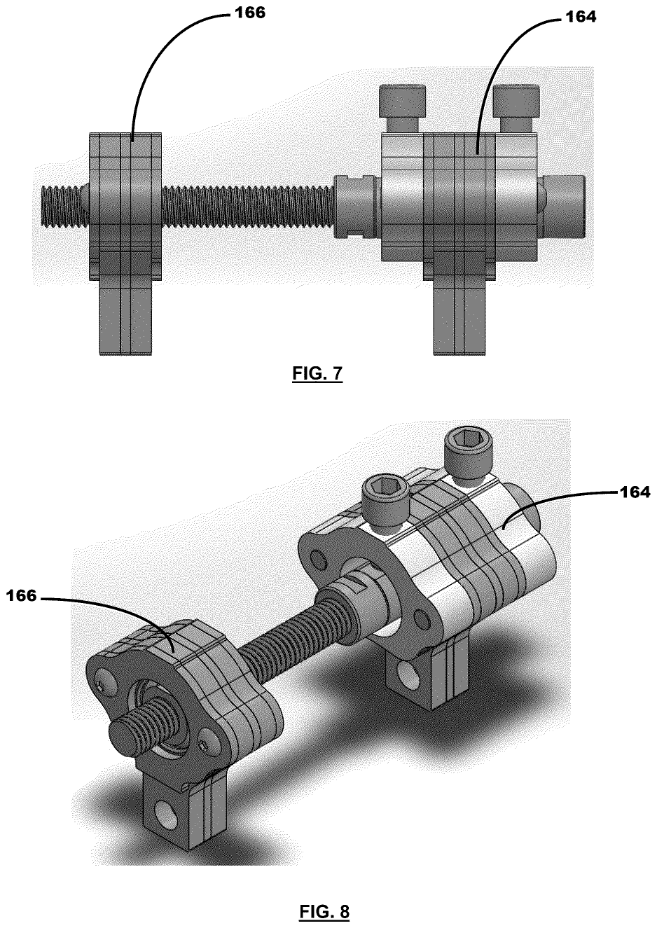

Each one of a first of plurality of the swivel mount assemblies 160, (FIGS. 4-14), can be coupled with each one of the first clamp jaw 22 and the second clamp jaw 24 of the first clamp member 16, and can be adjustable, to vary the longitudinal spacing between the first clamp jaw 22 and the second clamp jaw 24 of the first clamp member 16. Each one of a second plurality of the swivel mount assemblies 180, can be coupled with each one of the first clamp jaw 26 and the second clamp jaw 28 of the second clamp member 18, and can be adjustable to vary the longitudinal spacing between the first clamp jaw 26 and the second clamp jaw 28. The first plurality of swivel mount assemblies 160 a can be circumferentially spaced along the first clamp member 16, and the second plurality of swivel mount assemblies 180 can be circumferentially spaced along the second clamp member 18.

It can be desirable to have the first clamp jaw 22 and the second clamp jaw 24 of the first clamp member 16 move toward each other, and to have the first clamp jaw 26 and the second clamp jaw 28 of the second clamp member 18 move toward each other, when the mechanical fastener 165 of each one of the first plurality of swivel mount assemblies 160, and each one of the second plurality of swivel mount assemblies 180 is rotated in a first direction. Further, it can be desirable to have the first clamp jaw 22 and the second clamp jaw 24 move away from each other, and to have the first clamp jaw 26 and the second clamp jaw 28 move away from each other, when the mechanical fastener 165 of each one of the first plurality of swivel mount assemblies 160 and each one of the second plurality of swivel mount assemblies 180, respectively, is rotated in a second, opposite direction. This arrangement can be facilitated by the color coding of the rear swivel mount 164 and the forward swivel mount 166.

In one embodiment, the apparatus 10 can include two of the first plurality of swivel mount assemblies 160 and two of the second plurality of assemblies 180. Alternatively, one or both of the first plurality of swivel mount assemblies 160 and the second plurality of swivel mount assemblies 180 can include a single swivel mount xx, or more than two of the swivel mounts xx.

The apparatus 10 can include a plurality of circumferentially spaced spacers 44, with each being attached to one of the first clamp member 16 and the second clamp member 18. Each of the spacers 44 can be cylindrical and can define a hollow interior that can be configured to receive a fastener. In other embodiments, spacers having other shapes can be attached to the first clamp member 16 and the second clamp member 18. Each one of the first clamp jaw 22 and the second clamp jaw 24 of the first clamp member 16, and each one of the first clamp jaw 26 and the second clamp jaw 28 of the second clamp member 18, can include a first frame 46a and a second frame 46b, which can be longitudinally spaced from the first frame 46a, for example, by at least two of the spacers 44. Each of the spacers 44 can be attached to each one of the first frame 46a and the second frame 46b, for example, with a respective one of a plurality of fasteners 48, which can be rivets.

Each of the first frame 46a and the second frame 46b, of each one of the first clamp jaw 22 and the second clamp jaw 24 of the first clamp member 16, and each one of the first clamp jaw 26 and the second clamp jaw 28 of the second clamp member 18, can be constructed from a plurality of layered plates 50, or from a single plate or bar. Three plates 50 can be used for each of the first frame 46a and the second frame 46b. In other embodiments, one or both of the first frame 46a and the second frame 46b, of each of the first clamp jaw 22 and the second clamp jaw 24 of the first clamp member 16, and the first clamp jaw 26 and the second clamp jaw 28 of the second clamp member 18, can be constructed of other numbers of layered plates. The use of layered plates can result in ease of manufacturing and the associated cost reduction. The plates 50 of the first frame 46a can be aligned with one another, and with each of the plates 50 of the second frame 46b, for each of the first clamp jaw 22, the first clamp jaw 26, the second clamp jaw 24, and the second clamp jaw 28, which facilitates the use of apparatus 10 with straight sections of pipe, for example the first section of pipe P1 or the second section of pipe P2.

Each plate 50 of each of the first frame 46a and the second frame 46b, for each of the first clamp jaw 22 and the second clamp jaw 24 of the first clamp member 16, and each of the first clamp jaw 26 and the second clamp jaw 28 of the second clamp member 18, can define a plurality of apertures, which can be circumferentially spaced. In one embodiment, with respect to one of the plates 50 of one of the frames 46b, each plate 50 can define a plurality of apertures 52, which can be shaped to receive a fastener such as a rivet. In one embodiment, each of the apertures 52 can have a round shape. Each of the spacers 44 can be aligned with one of the apertures 52 in a respective one of the first frame 46a and the second frame 46b, to permit a fastener to pass through the first frame 46a, the spacer 44, and the second frame 46b, to attach the spacer 44 to each of the respective ones of the first frame 46a and the second frame 46b.

The first frame 46a of each one of the first clamp jaw 22 and the second clamp jaw 24 of the first clamp member 16, and the first clamp jaw 26 and the second clamp jaw 28 of the second clamp member 18, can include a first end 54a, a second end 55a circumferentially spaced from the first end 54a, and an inside surface 56a having a radius 57a. The first frame 46 a can extend arcuately from the first end 54a to the second end 55a. The radius 57a of the inside surface 56a can be at least substantially the same, i.e., the same or substantially the same, as the radius of the outside surface of the portion of the section of pipe that the first frame 46a surrounds. The second end 55a of the first frame 46a can include a radially outwardly extending portion 58a and an ear 59a extending transversely away from the radially outwardly extending portion 58a.

The second frame 46b of each one of the first clamp jaw 22 and the second clamp jaw 24 of the first clamp member 16, and the first clamp jaw 26 and the second clamp jaw 28 of the second clamp member 18, can include a first end 54b, a second end 55b circumferentially spaced from the first end 54b, and an inside surface 56b having a radius 57b. The second frame 46b can extend arcuately from the first end 54b, to the second end 55b. The radius 57b of the inside surface 56b can be at least substantially the same, i.e., the same or substantially the same, as the radius of the outside surface of the portion of the section of pipe that the second frame 46b surrounds. The second end 55b of the second frame 46b can include a radially outwardly extending portion 58b and an ear 59b extending transversely away from the radially outwardly extending portion 58b. The configurations of the radially outwardly extending portions 58a and 58b, and the ears 59a and 59b, can facilitate clamping the first clamp member 16 to the second clamp member 18.

Each of the hinges 20 can include an arcuate portion 64 and a flange portion 65 extending away from the arcuate portion 64. The flange portion 65 can have a generally triangular shape, which can define an aperture 66 that can be shaped and sized to receive a flexible member, for example, a cable, which can be used as a “tie-off”, to prevent the apparatus 10 from inadvertently falling during assembly of the apparatus 10 to two adjacent sections of pipe. In other embodiments, the flange portion 65 can have any one of a variety of other shapes. In still other embodiments, the flange portion 65 can be omitted, for example, the hinge 20. Each of the hinges 20 can include an edge surface 67 (FIG. 20). At least an inside portion 68 of the edge surface 67 can be arcuate, and can be sized so that the hinges 20 do not contact the arcuate outside surfaces of the respective sections of pipe as the clamp members 16 and 18 pivot around the respective sections of pipe, for example the first section of pipe P1 and the second section of pipe P2. Accordingly, the clamp members 16 and 18 can pivot freely around the first section of pipe P1 and the second section of pipe P2. Each of the hinges 20 can be constructed from multiple layers of plates 21 made from a metal alloy or metal, which can enhance the ease of manufacturing and can reduce cost. Alternatively, each hinge 20 can be constructed as a unitary structure.

The arcuate portion 64 of one of the hinges 20 can be pivotally coupled with each of the first frame 46a and the second frame 46b of the first clamp jaw 22 of the first clamp member 16, and with each of the first frame 46a and the second frame 46 b of the first clamp jaw 26 of the second clamp member 18. For example, one end of the arcuate portion 64 of the hinge 20 can be positioned within a space defined by the first frame 46a and the second frame 46b of the first clamp jaw 22 of the first clamp member 16, and pivotally coupled with each one of the first end 54a of the frame 46a, and the first end 54b of the frame 46b, of the first clamp jaw 22, using any suitable pivot member, e.g., rivets or clevis pins. The opposite end of the arcuate portion 64 of the hinge 20 can be similarly, pivotally coupled with each one of the first end 54a of the frame 46a, and the first end 54b of the frame 46b, of the first clamp jaw 26 of the second clamp member 18. The second hinge 20 can be similarly pivotally coupled with the second clamp jaw 24 of the first clamp member 16 and the second clamp jaw 28 of the second clamp member 18.

When the first clamp member 16 and the second clamp member 18 are positioned around respective portions of a first section of pipe P1 and a second section of pipe P2, and each is in the closed position, the first clamp member 16 and the second clamp member 18 can be secured to one another. In one embodiment, the first clamp member 16 and the second clamp member 18 can be clamped to one another.

Apparatus 10 can include a pair of latch bolts 70, which can be eye-bolts. One of the latch bolts 70 can be pivotally coupled with one of the first clamp jaw 26 of the second clamp member 18 (FIG. 4), and clamped to the first clamp jaw 22 of the first clamp member 16. The other latch bolt 70 can be pivotally coupled with the second clamp jaw 28 of the second clamp member 18 (FIG. 4), and clamped to the second clamp jaw 24 of the first clamp member 16.

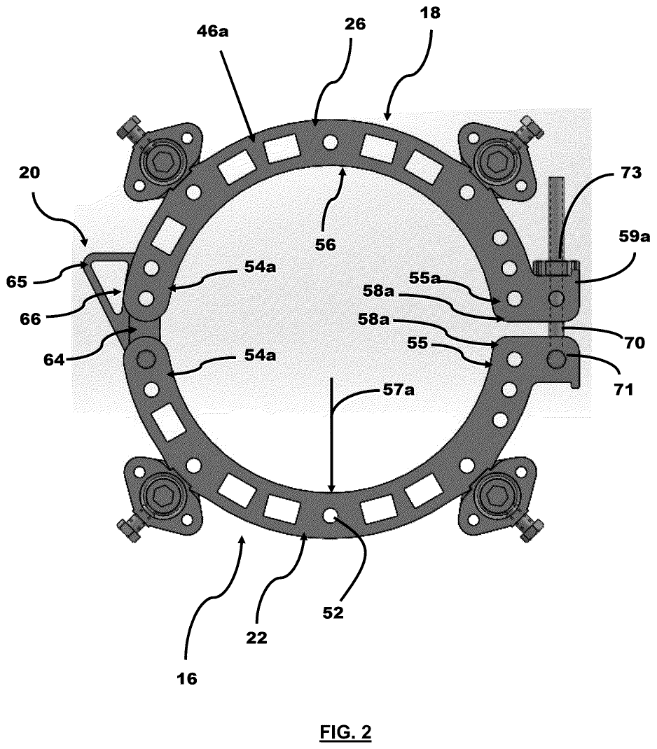

As an example of the pivotal coupling of the latch bolts 70, the latch bolt 70 pivotally coupled with the second clamp jaw 28 of the second clamp member 18 can be pivotally coupled with the second end 55a of the first frame 46a, and the second end 55b of the second frame 46b, of the second clamp jaw 28, as shown in FIG. 2. This can be accomplished with a pivot member 71, which can be a pin. The pivot member 71 can be inserted through an aperture defined by the second end 55 a of the first frame 46a, through an aperture defined by the latch bolt 70, and through an aperture defined by the second end 55b of the second frame 46b.

Apparatus 10 can include two latch plates, and one of the latch plates can be retained on each of the latch bolts 70 by a latch bolt nut 73. In one embodiment, the latch bolt 70 pivotally coupled with the second clamp jaw 28 of the second clamp member 18 can be rotated to position the respective latch plate 72 against the outwardly extending portion 58a of the second end 55a of the first frame 46a, and against the outwardly extending portion 58b of the second end 55b of the second frame 46b, of the second clamp jaw 24 of the first clamp member 16. The nut 73 can then be tightened to clamp the second clamp jaw 24 of the first clamp member 16 to the second clamp jaw 28 of the second clamp member 18. The shape and size of the latch plate can distribute the clamp load, or force, across the layered plates 50 of the first frame 46a and the second frame 46b of the second clamp jaw 24 of the first clamp member 16. The latch plate can also provide a wear surface for the nut 73. The ear 59a of the second end 55a of the first frame 46a, and the ear 59b of the second end 55b of the second frame 46b, of the second clamp jaw 24, can facilitate retaining the latch plate as the nut 73 is tightened. The latch bolt 70 pivotally coupled with the first clamp jaw 26 can be clamped to the first clamp jaw 22 in a similar manner. Alternatively, one of the latch bolts 70 can be pivotally coupled with the first clamp jaw 22 and clamped to the first clamp jaw 26. Also, the other latch bolt 70 can alternatively be pivotally coupled with second clamp jaw 24 and clamped to the second clamp jaw 28.

The first clamp member 16 and the second clamp member 18, can be hingedly coupled, with each being pivotally coupled with a pair of hinges (e.g., 20), which facilitates positioning apparatus 10 in surrounding relationship with the two sections of pipe to be joined. Once apparatus 10 is in position, the first clamp member 16 can be clamped to the second clamp member 18 so that each of the clamp members 16, 18 engages each section of pipe to be joined. This can securely hold the two sections of pipe during the welding process, which can enhance the accuracy of the weld.

The relative longitudinal positions of two adjacent sections of pipe can be accurately and easily adjusted using turnbuckle assemblies (e.g., 30). Each of the first clamp jaw 22 of the first clamp member 16 and the first clamp jaw 26 of the second clamp member 18, can partially surround, and be forced against, respective portions of a first section of pipe. Each of the second clamp jaw 24 of the first clamp member 16 and the second clamp jaw 28 of the second clamp member 18, can partially surround, and be forced against, respective portions of a second section of pipe. A first plurality of the swivel mount assemblies 160 can be coupled with each one of, and can vary the longitudinal spacing between, the first clamp jaw 22 and the second clamp jaw 24 of the first clamp member 16. Similarly, a second plurality of the swivel mount assemblies 180 can be coupled with each one of, and can vary the longitudinal spacing between, the first clamp jaw 26 and the second clamp jaw 28 of the second clamp member 18. Accordingly, the first plurality of the swivel mount assemblies 160 and the second plurality of the swivel mount assemblies 180 can be adjusted, by rotating the respective mechanical fastener xx disposed therethrough to accurately and easily adjust the longitudinal positions of the first and second sections of pipe.

The configuration of apparatus 10 can provide unobstructed access to the weld joint, which can enhance the accuracy and speed of the welding process. The unobstructed access results from the longitudinal spacing of the first clamp jaw 22 and the second clamp jaw 24 of the first clamp member 16, the longitudinal spacing of the first clamp jaw 26 and the second clamp jaw 28 of the second clamp member 18, the circumferential spacing of the first plurality of the swivel mount assemblies 160 along the first clamp member 16, and the circumferential spacing of the second plurality of the swivel mount assemblies 180 along the second clamp member 18.

Each of the frames (e.g., 46a, 46b) of each of the clamp jaws (e.g., 22, 24) of the first clamp member 16, and each of the frames (e.g., 46a, 46b) of each of the clamp jaws (e.g., 26, 28) of the second clamp member 18, can be constructed from a plurality of plates 50, for example three plates 50 in one embodiment, which can enhance the ease of manufacturing and reduce cost. Similarly, each of the hinges 20 can be constructed from multiple plates, for example, two or more plates, which can also enhance the ease of manufacturing and reduce cost.

Piping is generally available in standard sizing throughout the industry. Accordingly, the apparatus for aligning sections of pipe can be constructed to accommodate standard piping sizes.

In accordance with FIGS. 1 through 14, an apparatus 10 for aligning sections of pipe, the apparatus 10 comprising a first clamp member and a second clamp member. The first clamp member comprising a first clamp jaw and a second clamp jaw longitudinally spaced from the first clamp jaw. The second clamp member comprising a first clamp jaw and a second clamp jaw longitudinally spaced from the first clamp jaw.

In particular, regarding FIGS. 4 through 14, the apparatus 10 comprises a plurality of swivel mount assemblies 160 coupling the first clamp member and the second clamp member. Each one of the swivel mount assemblies 160 comprises a rear swivel mount 164 and a forward swivel mount 166, the rear swivel mount 164 and the forward swivel amount 166 coupled via a linearly elongated threaded mechanical fastener 165, and generally envisioned to include a swivel bolt.

Each one of the swivel mount assemblies 160 comprises a rear swivel mount 164 and a forward swivel mount 166. The rear swivel mount 164 and the forward swivel mount 166 are coupled via a connector 167 and socket 169 receiving the linearly elongated threaded mechanical fastener 165 therethrough. The coupling of rear swivel mount 164 and forward swivel mount 166 provides variable adjustment and positioning of the mechanical fastener 165 through multiple planes, including x, y, and z, accommodating concentric movement and/or eccentric movement as required or needed. The concentric and/or eccentric movement of the swivel mount assemblies 160 is accomplished through the inclusion of a first adjustable bolt 161 and a second adjustable bolt 163 disposed along the radius of the mechanical fastener 165, wherein adjustment of either or both of the first adjustable bolt 161 and/or the second adjustable bolt 163 urges the mechanical fastener 165 within multiple planes and/or positions. The first adjustable bolt 161 is disposed at the rear of the rear swivel mount 164 and controls movement of the pipe section P1 to which the rear swivel mount 164 is coupled. The second adjustable bolt 166 is disposed at the head of the rear swivel mount 164 and adjacent the placement of the forward swivel mount 166 on pipe section P2, within which the second adjustable bolt 163 controls movement of the pipe section P2 to which the forward swivel mount 166 is coupled.

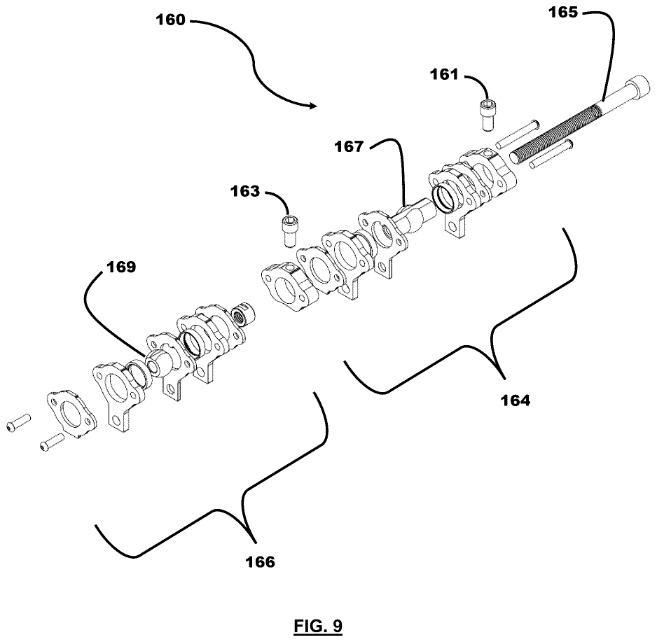

Consistent with FIG. 9, for each one of the swivel mount assemblies, the rear swivel mount 164 comprises a first rear coupler 164a having a concentric axial bore 164c and a second rear coupler 164b having a concentric axial bore 164d, the couplers 164a, 164b and concentric axial bores 164c, 164d aligned for receiving and housing the linearly elongated threaded mechanical fastener 165. The first rear coupler 164a and second rear coupler 164b further receive and house a barrel swivel connector 167, the barrel swivel connector 167 having internal threads complementary to the external threads of the mechanical fastener 165, and the barrel swivel connector 167 receiving and threadingly housing the mechanical fastener 165 therethrough.

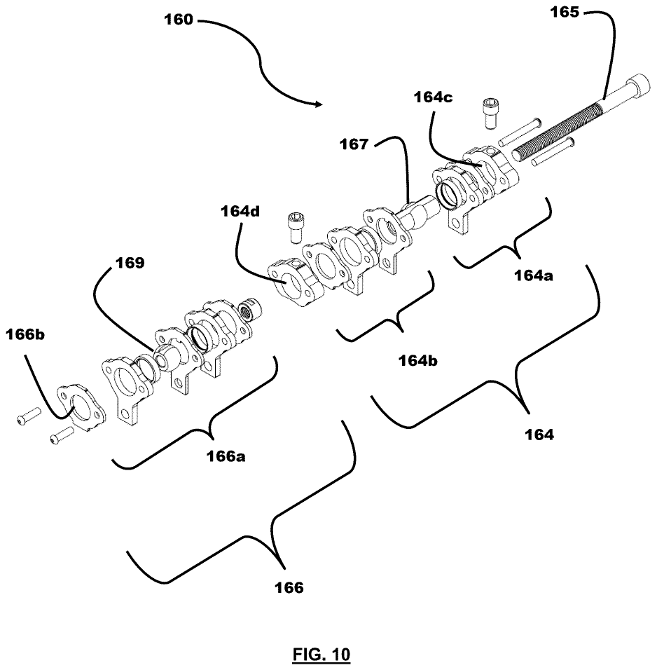

Consistent with FIG. 10, each one of the first rear couplers comprises a first rearward adjustable bolt saddle 164s, a first rearward retainer 164r, and a first rearward yoke 164y, the first rewardward retainer 164r disposed between the first rearward adjustable bolt saddle 164s and the first rearward yoke 164y. Each of the first rearward adjustable bolt saddle 164s, the first rearward retainer 164r, and the first rearward yoke 164y comprise a concentric axial bore 164c (illustrated in FIG. XI) aligned for receiving and housing the mechanical fastener 165 therethrough

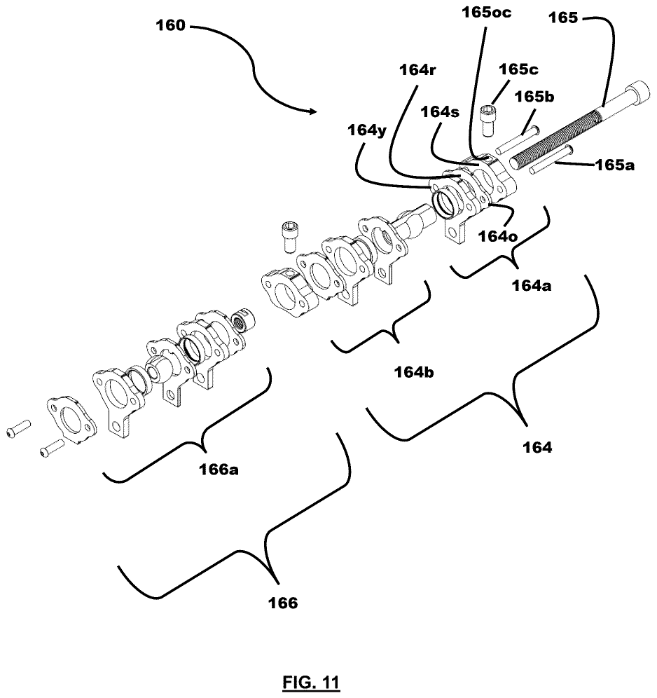

Also consistent with FIG. 11, it is envisioned that each one of the first rearward adjustable bolt saddle 164s, the first rearward retainer 164r, and the first rearward yoke 164y of the first rear coupler further comprises a plurality of upper longitudinal openings 164o parallel to the concentric axial bore 164c for accommodating a plurality of fasteners 165a and/or 165b for mechanically coupling the first rearward adjustable bolt saddle 164s, the first rearward retainer 164r, and the first rearward yoke 164y and forming the first rear coupler 164a. The first rearward adjustable bolt saddle 164s further comprises a threaded circumferential opening 164oc for housing and accommodating positioning of a threaded bolt 165c for manipulating the mechanical fastener 165 within the concentric axial bore 164c of the first rear coupler 164a.

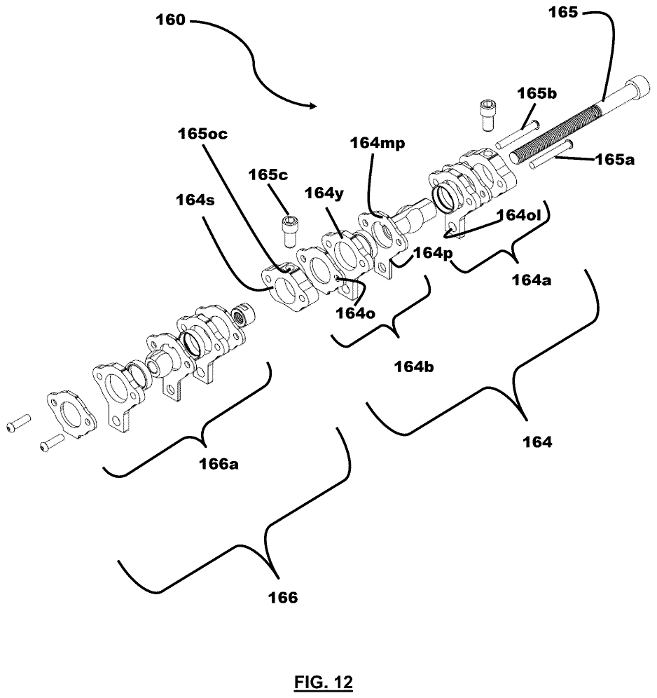

In a related embodiment, consistent with FIG. 12, and in the second rear coupler 164b, each one of the second rear couplers 164b comprises a mid-plate retainer 164mp, a second rearward yoke 164y, a second rearward retainer 164r, and second rearward adjustable bolt saddle 164s. Each of the mid-plate retainer 164mp, the second rearward yoke 164y, the second rearward retainer 164r, and the second rearward adjustable bolt saddle 164s comprises a concentrical axial bore 164d aligned for receiving and housing the mechanical fasterner 165 therethrough. Each of the mid-plate retainer 164mp, the second rearward yoke 164y, the second rearward retainer 164r, and the second rearward adjustable bolt saddle 164s of the second rear coupler 164b also include a plurality of openings 164o for accommodating a plurality of fasteners 165a and/or 165b for mechanically coupling Each of the mid-plate retainer 164mp, the second rearward yoke 164y, the second rearward retainer 164r, and the second rearward adjustable bolt saddle 164s. The second rearward adjustable bolt saddle 164s further comprises a threaded circumferential opening 165oc for housing and accommodating positioning of a threaded bolt 165c for manipulating the mechanical fastener 165 within the concentric axial bore 164d of the second rear coupler. 164b. In a related embodiment, the mid-plate retainer 164mp and the second rearward yoke 164y comprises a downwardly depending panel 164p comprising a lower longitudinal opening 165ol parallel to the concentric axial bore for accommodating a fastener. The first rear coupler 164a and the second rear coupler 164b mechanically joined together and affixed to the first clamp jaw of the first clamp member using at least one fastener secured through the lower longitudinal opening 165ol.

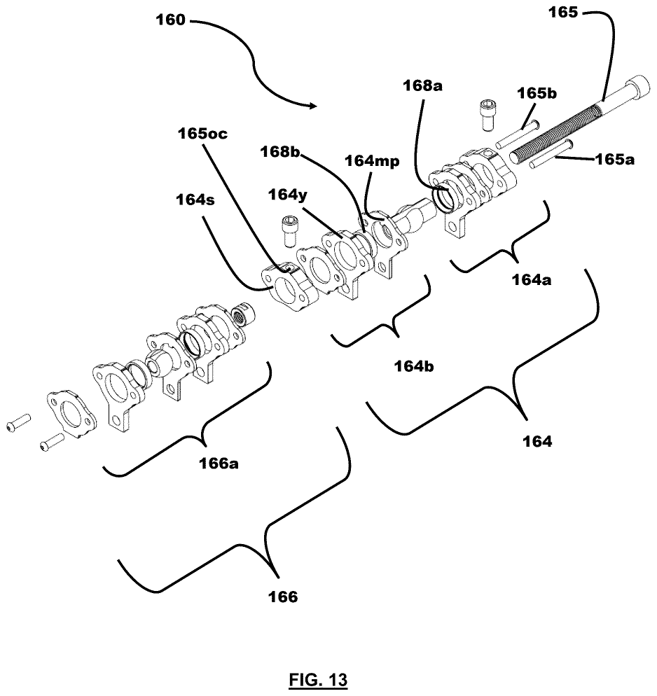

Consistent with FIG. 13, the first rear coupler 164a comprises a first rear race shim spacer disposed within the concentric axial bore 164c therein, the first rear race shim spacer 168a seating the first portion of the barrel swivel connector 167. The second rear coupler 164b comprises a second rear race shim spacer 168b disposed within the concentric axial bore 165d therein, the second rear race shim spacer 168b seating the second portion of the barrel swivel connector 167 opposing the first portion of the barrel swivel connector 167.

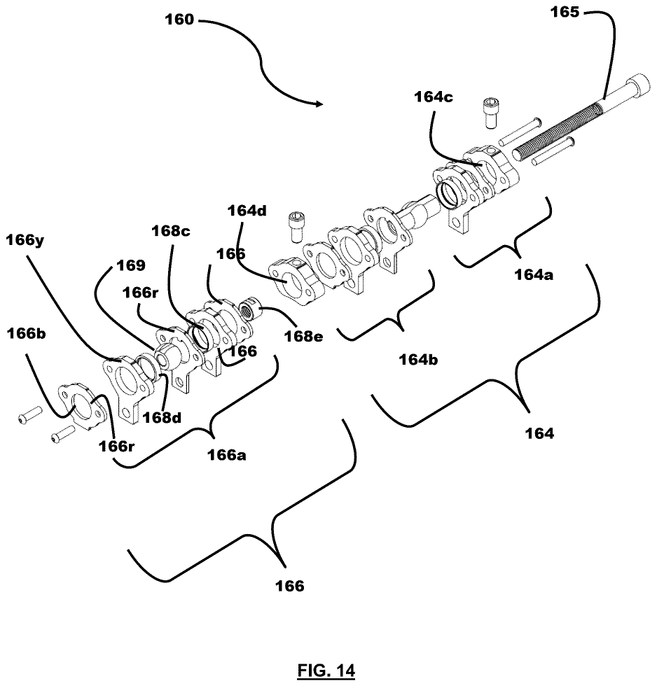

Also consistent with FIG. 14, for each one of the swivel mount assemblies 160, the forward swivel mount 166 comprises a forward coupler 166a having a concentric axial bore 166b aligned for receiving and housing the linearly elongated threaded mechanical fastener 165. The forward coupler 166a further receives and houses a socket 169 having internatl threads complementary to the external threads of the mechanical fastener 165. The socket 169 receives and threadedly houses the mechanical fastener 165 therethrough. The mechanical coupling of the rear swivel mount 164 through the barrel swivel connector 167 with the forward swivel mount 166 utilizing a threaded mechanical fastener 165 forms a single swivel mount assembly 160.

In the same or similar embodiment, and more particularly, the forward swivel mount 166 may further comprise a forward coupler 166a. Each one of the forward couplers 166a comprise a first forward retainer 166r, a first forward yoke 166y, a forward mid-plate 166mp, a second forward yoke 166y, and a second forward retainer 166r. Each one of the first forward retainer 166r, the first forward yoke 166y, the forward mid-plate 166mp, the second forward yoke 166y, and the second forward retainer 166r comprise a concentric axial bore 166b aligned for receiving and housing the linearly elongated threaded mechanical fastener 165 therethrough. The mechanical fastener 165 is the same fastener inserted through the concentric axial bores 164c, 164d of the first rear coupler 164a and the second rear coupler 164b. Each one of the first forward retainer 166r, the first forward yoke 166y, the forward mid-plate 166mp, the second forward yoke 166y, and the second forward retainer 166r also include a plurality of upper longitudinal openings 166o for accommodating a pluralty of fasteners 166a and/or 166b for mechanically coupling the first forward retainer 166r, the first forward yoke 166y, the forward mid-plate 166mp, the second forward yoke 166y, and the second forward retainer 166r in forming the forward swivel mount 166. wherein each one of the forward swivel mounts 166 further comprises a retainer nut 168e internally disposed along the forward swivel mount. Each one of the forward couplers comprises a socket 169 disposed therein for receiving and housing the mechanical fastener 165 for coupling the first rear coupler 164a and second rear coupler 164b with the forward coupler 166. It is further envisioned that the forward coupler 166 houses and retains a first forward racer 168c and a second forward racer 168d, wherein the first and second forward racers 168c, 168d mechanically communicate with the socket 169 disposed within the forward coupler 166a. Accordingly, each one of the rear swivel mounts 164 comprises a barrel swivel connector 167 disposed within the concentric axial bore 164a and 164b for housing a retaining the mechanical fastener 165 that also extends through and engages the forward swivel mount(s) 166 that further comprises the retainer nut 168e internally disposed along the forward swivel mount 166. The second portion of the mechanical fastener 165 engages the retainer nut 168e and the socket 169, and the first forward racer 168c and the second forward racer 168d form bookends to the socket 169.

It is to be understood that the embodiments and claims are not limited in its application to the details of construction and arrangement of the components set forth in the description and illustrated in the drawings. Rather, the description and the drawings provide examples of the embodiments envisioned, but the claims are limited to the specific embodiments. The embodiments and claims disclosed herein are further capable of other embodiments and of being practiced and carried out in various ways. Also, it is to be understood that the phraseology and terminology employed herein are for the purposes of description and should not be regarded as limiting the claims.

Accordingly, those skilled in the art will appreciate that the conception upon which the application and claims are based may be readily utilized as a basis for the design of other structures, methods, and systems for carrying out the several purposes of the embodiments and claims presented in this application. It is important, therefore, that the claims be regarded as including such equivalent constructions.

Furthermore, the purpose of the foregoing Abstract is to enable the U.S. Patent and Trademark Office and the public generally, and especially including the practitioners in the art who are not familiar with patent and legal terms or phraseology, to determine quickly from a cursory inspection the nature and essence of the technical disclosure of the application. The Abstract is neither intended to define the claims of the application, nor is it intended to be limiting to the scope of the claims in any way. It is intended that the application is defined by the claims appended hereto.

What is claimed is:

1. An apparatus for aligning sections of pipe, the apparatus comprising:
a first clamp member comprising a first clamp jaw and a second clamp jaw longitudinally spaced from the first clamp jaw;
a second clamp member comprising a first clamp jaw and a second clamp jaw longitudinally spaced from the first clamp jaw;
a first hinge comprising an elongated portion having a first aperture and a second aperture wherein the first aperture is spaced apart from the second aperture;
a first pivot member inserted through the first aperture of the first hinge and pivotally coupling the first hinge to the first clamp jaw of the first clamp member;
a second pivot member inserted into the second aperture of the first hinge and pivotally coupling the first hinge to the first clamp jaw of the second clamp member;
a second hinge comprising an elongated portion having a first aperture and a second aperture wherein the first aperture is spaced apart from the second aperture;
a third pivot member inserted through the first aperture of the second hinge and pivotally coupling the second hinge to the second clamp jaw of the first clamp member;
a fourth pivot member inserted into the second aperture of the second hinge and pivotally coupling the second hinge to the second clamp jaw of the second clamp member;
a first plurality of swivel mount assemblies, each one of the first plurality of swivel mount assemblies being coupled with each one of, and adjustable to vary the longitudinal spacing between, the first clamp jaw and the second clamp jaw of the first clamp member; and
a second plurality of swivel mount assemblies, each one of the second plurality of swivel assemblies being coupled with each one of, and adjustable to vary the longitudinal spacing between, the first clamp jaw and the second clamp jaw of the second clamp member.

2. The apparatus of claim 1, wherein:
each one of the first clamp member and the second clamp member is pivotable between an open position and a closed position;
the first clamp member is secured to the second clamp member when each one of the first clamp member and the second clamp member is in the respective closed position;
each one of the first clamp jaw of the first clamp member and the first clamp jaw of the second clamp member is configured to surround and engage a respective portion of a first section of pipe when each one of the first clamp member and the second clamp member is in the respective closed position; and
each one of the second clamp jaw of the first clamp member and the second clamp jaw of the second clamp member is configured to surround and engage a respective portion of a second section of pipe when each one of the first clamp member and the second clamp member is in the respective closed position.

3. The apparatus of claim 2, further comprising:
a plurality of swivel mounts, each one of the swivel mounts comprising a rear swivel mount and a forward swivel mount integral with the rear swivel mount; wherein, each one of a first plurality of the swivel mounts couples a respective one of the first plurality of swivel mount assemblies with the first clamp jaw of the first clamp member;
each one of a second plurality of the swivel mounts couples a respective one of the first plurality of swivel mount assemblies with the second clamp jaw of the first clamp member;
each one of a third plurality of the swivel mounts couples a respective one of the second plurality of swivel mount assemblies with the first clamp jaw of the second clamp member; and
each one of a fourth plurality of the swivel mounts couples a respective one of the second plurality of swivel mount assemblies with the second clamp jaw of the second clamp member.

4. The apparatus of claim 3, wherein:
each one of the plurality of swivel mounts comprises a mechanical fastener, a socket secured to the mechanical fastener, a barrel swivel connector threadedly engaged with a first portion of the mechanical fastener within the rear swivel mount, and a retainer nut threadedly engaged with a second portion of the mechanical fastener within the forward swivel mount, the retainer nut disposed between the barrel swivel connector and the socket.

5. The apparatus of claim 4, wherein the coupling of each rear swivel mount with each forward swivel mount provides variable adjustment and positioning of the mechanical fastener through multiple planes and accommodating centric movement and eccentric movement, the variable adjustment and positioning of the mechanical fastener relative to the rear swivel mount and the forward swivel mount yielding variable positioning of the rear swivel mount and the forward swivel mount.

6. The apparatus of claim 4, wherein each one of the plurality of swivel mounts comprises:
a rear swivel mount comprising a first rear coupler and a second rear coupler, the first rear coupler and the second rear coupler fixed to the first clamp jaw of the first clamp member; and
a forward swivel mount comprising a forward coupler, the forward coupler fixed to the second clamp jaw of the first clamp member.

7. The apparatus of claim 6, wherein each one of the first rear couplers comprises a first rearward adjustable bolt saddle, a first rearward retainer, and a first rearward yoke, the first rewardward retainer disposed between the first rearward adjustable bolt saddle and the first rearward yoke, and wherein each of the first rearward adjustable bolt saddle, the first rearward retainer, and the first rearward yoke comprise a concentric axial bore aligned for receiving and housing the mechanical fastener therethrough.

8. The apparatus of claim 7, wherein each one of the first rearward adjustable bolt saddle, the first rearward retainer, and the first rearward yoke of the first rear coupler further comprises a plurality of longitudinal openings parallel to the concentric axial bore for accommodating a plurality of fasteners for mechanically coupling the first rearward adjustable bolt saddle, the first rearward retainer, and the first rearward yoke and forming the first rear coupler.

9. The apparatus of claim 8, wherein the first rearward adjustable bolt saddle further comprises a threaded circumferential opening for housing and accommodating positioning of a threaded bolt for manipulating the mechanical fastener within the concentric axial bore of the first rear coupler.

10. The apparatus of claim 6, wherein each one of the second rear couplers comprises a mid-plate retainer, a second rearward yoke, a second rearward retainer, and a second rearward adjustable bolt saddle, wherein each of the mid-plate retainer, the second rearward yoke, the second rearward retainer, and the second rearward adjustable bolt saddle comprises a concentrical axial bore aligned for receiving and housing the mechanical fasterner therethrough.

11. The apparatus of claim 10, wherein each one of the mid-plate retainer, the second rearward yoke, the second rearward retainer, and the second rearward adjustable bolt saddle of the second rear coupler xx further comprise a plurality of longitudinal openings parallel to the concentric axial bore for accommodating a plurality of fasteners for mechanically coupling the the mid-plate retainer, the second rearward yoke, the second rearward retainer, and the second rearward adjustable bolt saddle.

12. The apparatus of claim 11, wherein the second rearward adjustable bolt saddle further comprises a threaded circumferential opening for housing and accommodating positioning of a threaded bolt for manipulating the mechanical fastener within the concentric axial bore of the second rear coupler.

13. The apparatus of claim 6, wherein each one of the first rear coupler and the second rear coupler comprise a concentric axial bore formed therethrough.

14. The apparatus of claim 13, wherein the first rear coupler and the second rear coupler receive and accommodate a connector through the concentrical axial bore, and wherein the connector comprises a barrel swivel connector having internal threads and threadedly mateable with the mechanical fastener, and wherein the first rear coupler comprises a first rear race shim spacer disposed within the concentric axial bore therein, the first rear race shim spacer seating the first portion of the barrel swivel connector.

15. The apparatus of claim 14, wherein the second rear coupler comprises a second rear race shim spacer disposed within the concentric axial bore therein, the second rear race shim spacer seating the second portion of the barrel swivel connector opposing the first portion of the barrel swivel connector.

16. The apparatus of claim 15, wherein each one of the first rear coupler and the second rear coupler comprise a downwardly depending panel comprising a lower longitudinal opening parallel to the concentric axial bore for accommodating a fastener for mechanically coupling the first rear coupler and the second rear coupler therethrough and to the first clamp jaw of the first clamp member.

17. The apparatus of claim 16, wherein:
each one of the first rear couplers comprises:
a first rearward adjustable bolt saddle, the first rearward retainer, and the first rearward yoke, the first rearward retainer disposed between the first rearward adjustable bolt saddle and the first rearward yoke, and wherein each of the first rearward adjustable bolt saddle, the first rearward retainer, and the first rearward yoke comprise a concentric axial bore aligned for receiving and housing the mechanical fastener therethrough;
the first rearward yoke comprising a downwardly depending panel comprising a lower longitudinal opening parallel to the concentric axial bore for a accommodating a fastener;
each one of the second rear couplers comprises:
a mid-plate, a second rearward yoke, a retainer, and a saddle, and wherein each of the mid-plate, a second rearward yoke, retainer, and saddle comprise a concentrical axial bore aligned for receiving and housing the mechanical fasterner therethrough;
the mid-plate and second rearward yoke comprising a downwardly depending panel comprising a lower longitudinal opening parallel to the concentric axial bore for accommodating a fastener;
the first rear coupler and the second rear coupler mechanically joined together and affixed to the first clamp jaw of the first clamp member.

18. The apparatus of claim 17, wherein:
each one of the first rearward adjustable bolt saddle, the first rearward retainer, and the first rearward yoke of the first rear coupler further comprises a plurality of upper longitudinal openings parallel to the concentric axial bore for accommodating a plurality of fasteners for mechanically coupling the first rearward adjustable bolt saddle, the first rearward retainer, and the first rearward yoke along an upper portion; and,
wherein the first rearward adjustable bolt saddle further comprises a threaded circumferential opening for housing and accommodating positioning of a threaded bolt for manipulating the mechanical fastener within the concentric axial bore of the first rear coupler;
each one of the mid-plate retainer, the second rearward yoke, the second rearward retainer, and the second rearward adjustable bolt saddle of the second rear coupler further comprise a plurality of longitudinal openings parallel to the concentric axial bore for accommodating a plurality of fasteners for mechanically coupling the the mid-plate retainer, the second rearward yoke, the second rearward retainer, and the second rearward adjustable bolt saddle; and,
wherein the second rearward adjustable bolt saddle further comprises a threaded circumferential opening for housing and accommodating positioning of a threaded bolt for manipulating the mechanical fastener within the concentric axial bore of the second rear coupler; and,
the threaded bolt for the first rearward adjustable bolt saddle on the first rear coupler controls the first pipe section to which the first rear coupler is affixed and the threaded bolt for the second rearward adjustable bolt saddle on the second rear coupler controls the second pipe section to which the second rear coupler is affixed.

19. The apparatus of claim 18, wherein each one of the forward couplers comprises a first forward retainer, a first forward yoke, a forward mid-plate, a second forward yoke, and a second forward retainer, wherein each one of the first forward retainer, the first forward yoke, the forward mid-plate, the second forward yoke, and the second forward retainer comprise a concentric axial bore aligned for receiving and housing the mechanical fastener therethrough.

20. The apparatus of claim 19, wherein the the first forward retainer, the first forward yoke, the forward mid-plate, the second forward yoke, and the second forward retainer further comprise a plurality of longitudinal openings parallel to the concentric axial bore for accommodating a plurality of fasteners for mechanically coupling the the first forward retainer, the first forward yoke, the forward mid-plate, the second forward yoke, and the second forward retainer.
